(19) United States
(12) Patent Application Publication
(10) Pub. No.: US 2022/0368946 A1
(43) Pub. Date: Nov. 17, 2022

(54) HETEROGENEOUS REAL-TIME STREAMING AND DECODING OF ULTRA-HIGH RESOLUTION VIDEO CONTENT

(71) Applicant: Intel Corporation, Santa Clara, CA (US)

(72) Inventors: Junyong Ding, Shanghai (CN); Mohammad Haghighat, San Jose, CA (US); Lei Zhai, Shanghai (CN); Gang Shen, Hillsboro, OR (US); Jianhui Dai, Shanghai (CN); Hua Zhang, Shanghai (CN); Yanying Sun, Shanghai (CN)

(21) Appl. No.: 17/762,404

(22) PCT Filed: Nov. 7, 2019
(86) PCT No.: PCT/CN2019/116176

§ 371 Date: Mar. 22, 2022

(51) Int. Cl. H04N 19/597; H04N 19/105; H04N 19/44

(52) U.S. Cl. CPC H04N 19/597; H04N 19/105; H04N 19/44

(57) ABSTRACT

Systems, apparatuses and methods may provide for encoder technology that selects, in response to a request from a client device, a first video stream from a first plurality of video streams dedicated to a first tile in video content and selects, in response to the request, a second video stream from a second plurality of video streams dedicated to a second tile in the video content. The encoder technology may also send the selected first and second video streams to a client device. Additionally, decoder technology may allocate a first decoder device to the first video stream and allocate a second decoder device to the second video stream. In one example, the first video stream and the second video stream include one or more different codec parameter values.

### TECHNICAL FIELD

Embodiments generally relate to video streaming. More particularly, embodiments relate to heterogeneous real-time streaming and decoding of ultra-high resolution video content.

### BACKGROUND

Ultra-high resolution (e.g., 8k pixels or more digital video formats having a 16:9 aspect ratio) encoding may be used to stream virtual reality (VR), 360° video and/or cloud gaming content to client devices such as head-mounted displays (HMDs). Streaming such content may present challenges, however, with regard to communication and computation. For example, demands on networking bandwidth may be significantly increased and decoding the content at the client device may involve substantially more computation capacity.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a streaming architecture according to an embodiment;

FIG. 2 is a messaging diagram of an example of communications between a server and a stream manager according to an embodiment;

FIG. 3 is a block diagram of an example of a decoder device capability determination according to an embodiment;

FIGS. 4A and 4B are block diagrams of examples of video stream allocations according to embodiments;

FIG. 5 is a block diagram of an example of a merger of decoded video streams according to an embodiment;

FIG. 6A is a flowchart of an example of a method of operating a stream encoder according to an embodiment;

FIG. 6B is a flowchart of an example of a method of operating a stream decoder according to an embodiment;

FIG. 7 is a block diagram of an example of a Real-Time Transport Protocol (RTP) streaming architecture according to an embodiment;

FIG. 8 is a block diagram of an example of a performance-enhanced computing system according to an embodiment;

FIG. 9 is an illustration of an example of a semiconductor apparatus according to an embodiment;

FIG. 10 is a block diagram of an example of a processor according to an embodiment; and

FIG. 11 is a block diagram of an example of a multi-processor based computing system according to an embodiment.

### DESCRIPTION OF EMBODIMENTS

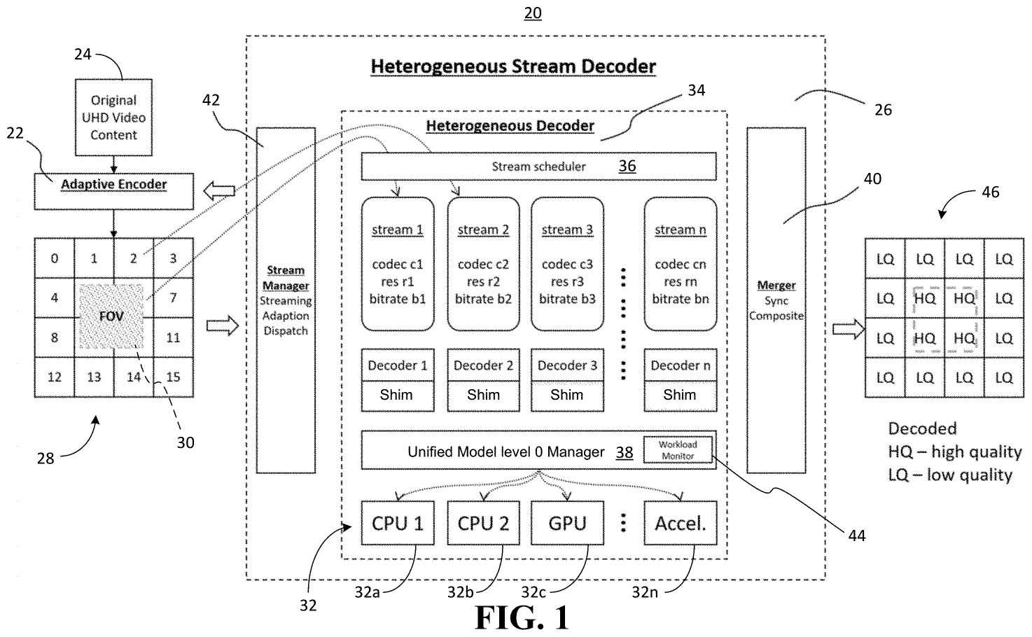

Turning now to FIG. 1, a streaming architecture 20 is shown in which an adaptive encoder 22 (e.g., operating in a server, not shown) receives original video content 24. In the illustrated example, the video content 24 is in an ultra-high definition (UHD, e.g., 4k pixels or more) digital video format. In an embodiment, the video content 24 includes VR, 360° video and/or cloud gaming content to be streamed, via a stream manager 42, to a heterogeneous stream decoder 26 that resides in a client device such as, for example, an HMD worn by an end user. The adaptive encoder 22 may partition each frame of the video content 24 into a plurality of tiles 28, with each tile 28 being encoded and encapsulated as a standalone stream. Additionally, each tile 28 may be encoded with different codec (coder-decoder) parameter options/values (e.g., codec type, resolution, bit rate). For example, tiles 28 within a field of view (FOV, e.g., corresponding to the direction in which the end user is looking) 30 might be given relatively high quality (HQ) codec parameter values, whereas tiles 28 outside the FOV 30 may be given relatively low quality (LQ) codec parameter values.

In the illustrated example, “stream 1” is dedicated to tile “6” (not shown) and has the codec parameter values of codec c1, resolution (“res”) r1, and bitrate b1, whereas “stream 2” is dedicated to tile “2” and has the codec parameter values of codec c2, resolution r2, and bitrate b2 (i.e., c1 may be different from c2, r1 may be different from r2, b1 may be different from b2, and so forth). A heterogeneous decoder 34 may include a stream scheduler 36 that submits the streams to a unified programming model level 0 manager 38 via abstracted decoders 1-n and corresponding shims (e.g., small API conversion libraries) for execution on the decoder devices 32. In an embodiment, the unified programming model is the ONEAPI model, which is used to program a heterogeneous set of decoder devices 32 (32a-32n) including, for example, a first CPU (central processing unit, e.g., host processor having a relatively small processor core) 32a, a second CPU 32b (e.g., host processor having a relatively large processor core), a graphics processing unit (GPU) 32c, a special-purpose accelerator 32n (e.g., field programmable gate array/FPGA, artificial intelligence/IA accelerator), and so forth. The illustrated level 0 manager 38 includes a workload monitor 44 to track the workload, power efficiency, capabilities, etc., of the decoder devices 32 in real-time. A merger component 40 may synchronize and composite the results from the decoder devices 32 into a visual output 46 to be presented on a display (e.g., of an HMD, not shown).

Sending the video streams to the stream decoder 26 on the illustrated per tile basis enhances performance in terms of communication and computation. More particularly, the LQ codec parameter values (e.g., lower resolution, lower bit rate, etc.) reduce demand on networking bandwidth in the communication channel between the encoder 22 and the stream manager 42 and reduces computational overhead in both the server and the client device. Additionally, the stream decoder 26 may allocate the video streams across the heterogeneous set of decoder devices 32 more efficiently.

In an embodiment, the adaptive encoder 22 dynamically changes the codec parameter options and/or switches between tile video streams in response to requests from the stream decoder 26 during runtime. For example, the stream decoder 26 might determine that the current FOV 30 has changed and request that the encoder 22 select an HQ video stream rather than an LQ video stream for a tile 28 that was previously outside the FOV 30 (e.g., tile “0”). The stream decoder 26 may also request the switch in response to other conditions such as, for example, a change in workload, power efficiency, capability, etc., of the decoder devices 32. Additionally, the level 0 manager 38 may dynamically migrate streams across the decoder devices 32 (e.g., switch at key frame) in response to overloads, workload balancing decisions, pluggable hardware decoder availability, errors, etc., or any combination thereof.

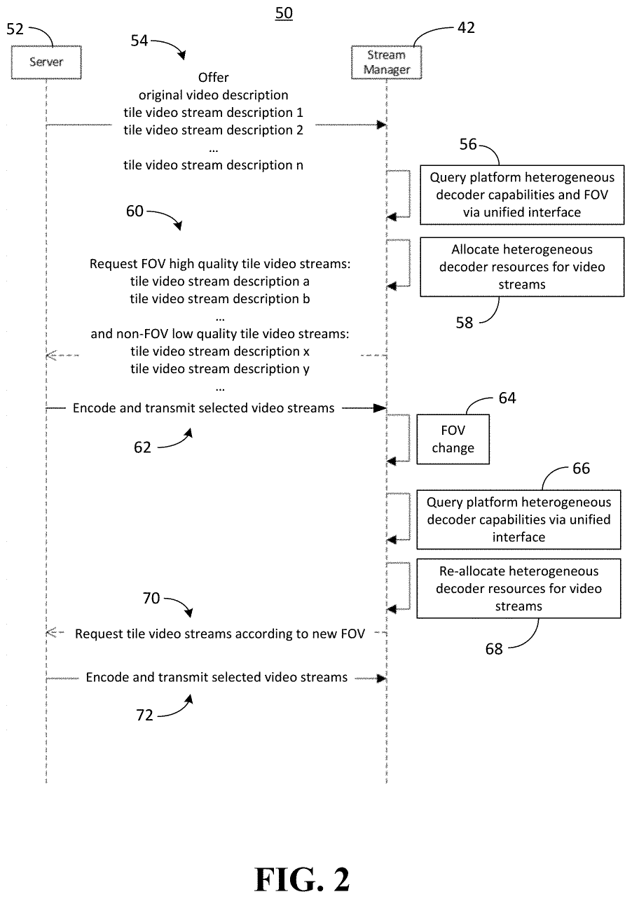

FIG. 2 shows a messaging diagram 50 for communications between the stream manager 42 and a server 52 that includes an adaptive encoder such as, for example, the adaptive encoder 22 (FIG. 1). The server may encode each tile separately and potentially multiple times (e.g., with different codec parameter values to obtain a plurality of streams for each tile). The multiple encoded files may be prepared in advance or encoded in real-time after a streaming session is established. In the illustrated example, a notification/offer communication 54 (e.g., message or set of messages) indicates the original video description (e.g., resolution, number of tiles in width, number of tiles in height, etc.) and the codec parameter values (e.g., tile video stream descriptions 1-n including codec, resolution, bit rate tile identifier/ID, etc.) of the video streams. As already noted, each video stream is dedicated to a tile in the video content. The stream manager 42 may initiate a query operation 56 via the unified interface (e.g., ONEAPI) to determine the current FOV and heterogeneous decoder capabilities. In an embodiment, the unified interface also conducts an allocation operation 58 to allocate heterogeneous decoder resources for the video streams.

A request communication 60 may request relatively high quality video streams for tiles within the current FOV (e.g., tile video stream descriptions a-b) and relatively low quality video streams for tiles not within the current FOV (e.g., tile video stream descriptions x-y). In the illustrated example, a stream communication 62 encodes and transmits the selected video streams.

In response to a change 64 in the FOV (e.g., detected via motion sensors, cameras, etc.), the unified interface conducts another query operation 66 to determine the heterogeneous decoder capabilities and a re-allocation operation 68 to allocate heterogeneous decoder resources for the video streams. The stream manager 42 may then issue a request communication 70 (e.g., re-negotiation message) to the server 52 according to the new FOV, where a stream communication 72 encodes and transmits the selected video streams.

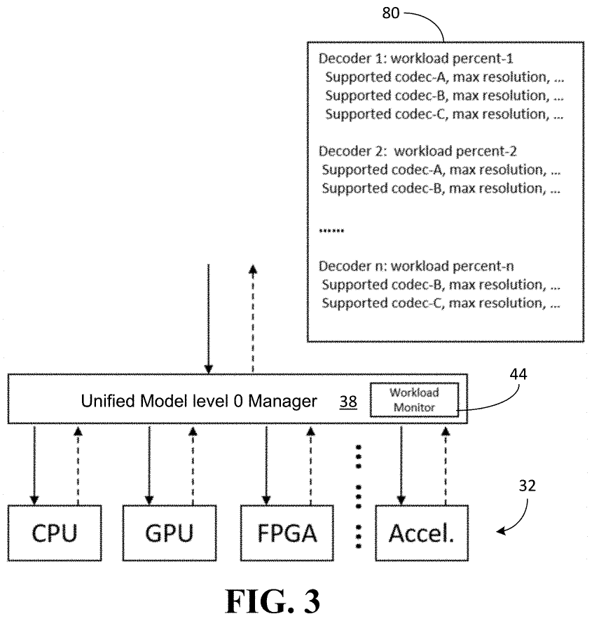

FIG. 3 shows a capability determination 80 that is generated and/or obtained by the level 0 manager 38 with respect to the decoder devices 32. Based on the capability determination 80, the stream manager may select streams dynamically. For example, the stream manager might select relatively high quality tile streams inside the FOV, and relatively low quality tile streams in non-FOV regions. According to the workload of the decoder devices 32 (e.g., underlying hardware), the allocation operation may give priority to decoders devices 32 with lower workloads for better system-wide load balancing. In another example, the allocation operation may optimize platform power consumption by prioritizing the tile streams that are supported by the most power efficient decoder devices 32. One such power efficient allocation approach is described in the pseudocode below.
Input: Received all tile video steam descriptions: S_{desc}
Current Field of View: f
Platform heterogeneous decoder capabilities: HD_{caps}
Output: Allocated heterogeneous decoders: DEC_{alloc}
PHD_{caps}=Prioritize HD_{caps} according to power efficiency (e.g., FPGA>GPU>CPU)
FoVS_{desc}=Select tile video steam descriptions from S_{desc}; High-quality tile streams in f, and low-quality tile streams not in f.

```
/* Loop all alternative tile video stream descriptions according to tile_id
*/
forall sdₜᵢₗₑ_{_{—}}_{id} in FoVS_{desc} do
  forall hdᵢ in PHD_{caps} do
    forall sdᵢ in sdₜᵢₗₑ_{_{—}}_{id} do
      if hd_{i workload} > sdᵢ AND hdᵢ matches sdᵢ then
        DEC_{alloc} = DEC_{alloc} + hdᵢ /* allocate this decoder */
        hd_{i workload} −= sdᵢ /* Reduce available workload of
this decoder */
        break loop /* go to next tile_id stream allocation */
      else /* Try alternative stream to match this decoder */
        continue
      end
    end
  end
end
return DEC_{alloc}
```

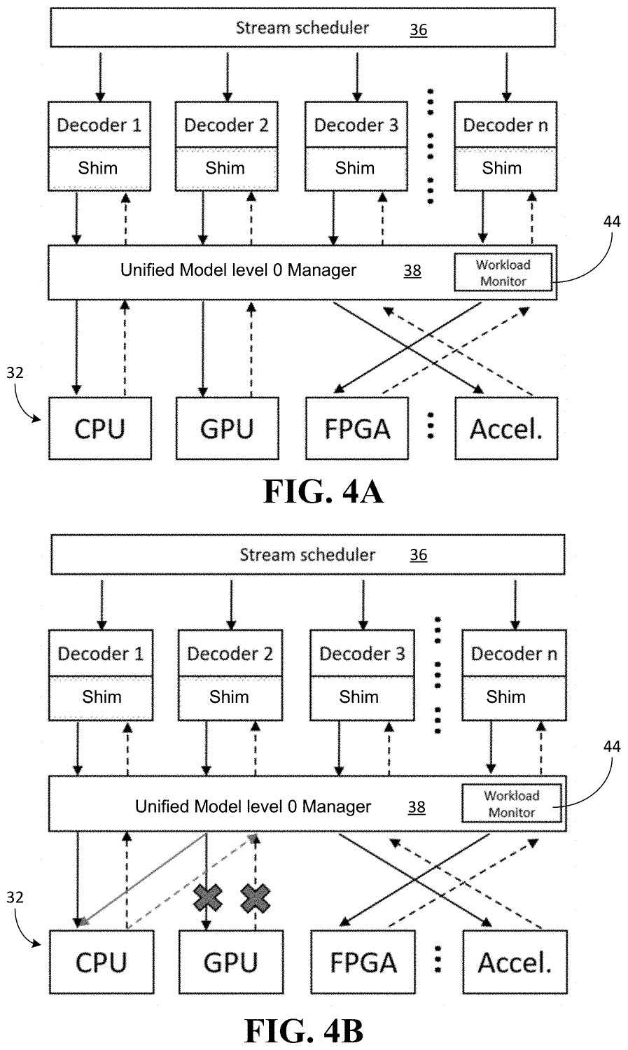

Turning now to FIG. 4A, the stream manager then sends the streams to the heterogeneous decoder 34 (FIG. 1) and the stream scheduler 36 dispatches each stream to an abstracted decoder (e.g., Decoders 1-n). The level 0 manager 38 may dynamically setup a map between the abstracted decoders and the decoder devices 32 (e.g., underlying hardware decoders).

FIG. 4B demonstrates that the illustrated level 0 manager 38 regularly monitors the status and workload of all decoder devices 32 and establishes a new map between abstracted decoders and the decoder devices 32 in the case of 1) overload (e.g., new tasks from other applications occupy the current hardware decoder computing resource), 2) error resilience (e.g., hardware decoding error), and/or 3) workload balancing (e.g., new pluggable hardware decoding device is discovered as available). Thus, the re-map is fully controlled by the level 0 manager 38, without awareness by upper layers in the application stack.

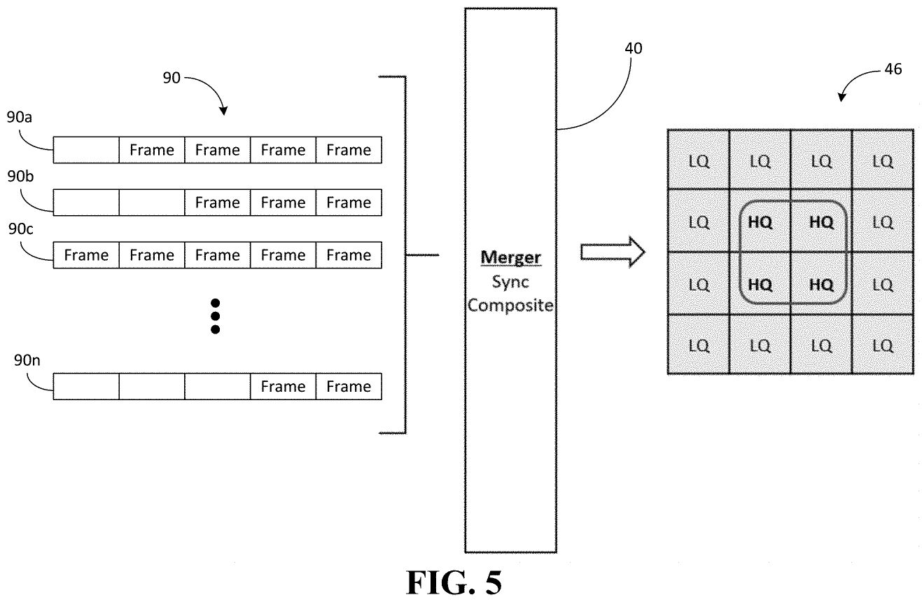

FIG. 5 demonstrates that the output of the decoder devices is frame tiles that are pushed into multiple queues 90 (90a-90n), where each queue 90 maps to the stream of a tile. For example, a first queue 90a may map to the video stream of a first tile, a second queue 90b may map to the video stream of a second tile, and so forth. The merger component 40 synchronizes all streams and composites the decoded tiles with the same timestamp into the visual output 46, which is a full frame picture (e.g. 360-degree panorama picture).

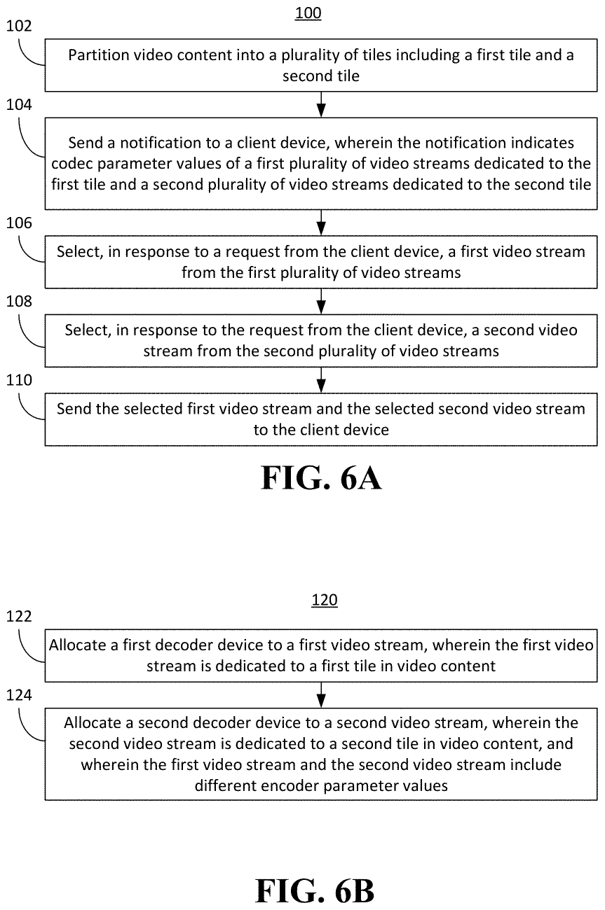

FIG. 6A shows a method 100 of operating a stream encoder. The method 100 may generally be implemented in a stream encoder such as, for example, the adaptive encoder 22 (FIG. 1), already discussed. More particularly, the method 100 may be implemented as one or more modules in a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), FPGAs, complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 100 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 102 partitions video content into a plurality of tiles including a first tile and a second tile. Although two tiles are described for discussion purposes, the number of tiles may vary and is typically greater than two. In an embodiment, the video content is a 360-degree (360°) frame of the video content. A notification may be sent to a client device at block 104, wherein the notification indicates codec parameter values of a first plurality of video streams dedicated to the first tile and a second plurality of video streams dedicated to the second tile. For example, the first plurality of video streams might include a relatively high quality video stream and a relatively low quality video stream, which are both dedicated to the first tile. Similarly, the second plurality of video streams may include a relatively high quality video stream and a relatively low quality video stream, which are both dedicated to the second tile. Intermediate levels of quality may also be encoded into the video streams.

Block 106 selects, in response to a request from the client device, a first video stream from the first plurality of video streams. Thus, if the first tile is within the current FOV, the first video stream may be a relatively high quality video stream. Block 108 selects, in response to the request from the client device, a second video stream from the second plurality of video streams. Thus, if the second tile is not within the current FOV, the second video stream might be a relatively low quality video stream. Accordingly, the first video stream and the second video stream may include one or more different codec parameter values (e.g., different codec types, different resolutions, different bit rates, etc.). Block 110 may provide for sending the selected first video stream and the selected second video stream to the client device. The method 100 may be repeated dynamically and in real-time as changes in the FOV are detected at the client device.

Streaming the video content to the client device on the illustrated per tile basis enhances performance in terms of communication and computation. More particularly, LQ codec parameter values (e.g., lower resolution, lower bit rate, etc.) reduce demand on networking bandwidth in the communication channel between the server and the client device and reduce computational overhead in both the server and the client device. Additionally, the client device may allocate the video streams across a heterogeneous set of decoder devices more efficiently.

FIG. 6B shows a method 120 of operating a stream decoder. The method 120 may generally be implemented in a stream decoder such as, for example, the heterogeneous stream decoder 26 (FIG. 1), already discussed. More particularly, the method 120 may be implemented as one or more modules in a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 122 allocates and/or maps a first decoder device to a first video stream, wherein the first video stream is dedicated to a first tile in video content (e.g., 360-degree video content). Additionally, block 124 allocates and/or maps a second decoder device to a second video stream, wherein the second video stream is dedicated to a second tile in the video content, and wherein the first video stream and the second video stream include different encoder parameter values. For example, the first video stream might have a high quality codec type, high resolution and/or high bit rate compared to the codec type, resolution and/or bit rate of the second video stream.

Moreover, blocks 122 and 124 may be conducted based on the current FOV, the workload state of heterogeneous decoder devices in the client device, the power efficiency of heterogeneous decoder devices in the client device and/or a notification from the server. In an embodiment, the notification from the server indicates codec parameter values of a first plurality of video streams including the first video stream and a second plurality of video streams including the second video stream. In such a case, the method 120 may further send a request to the server based on the notification, the current FOV, and one or more of the workload state or the power efficiency of the heterogeneous decoder devices in the client device.

The illustrated method 120 therefore enhances performance in terms of communication and computation. More particularly, LQ codec parameter values (e.g., lower resolution, lower bit rate, etc.) reduce demand on networking bandwidth in the communication channel between the server and the client device and reduce computational overhead in both the server and the client device. Additionally, mapping the video streams across a heterogeneous set of decoder devices more efficiently further enhances performance.

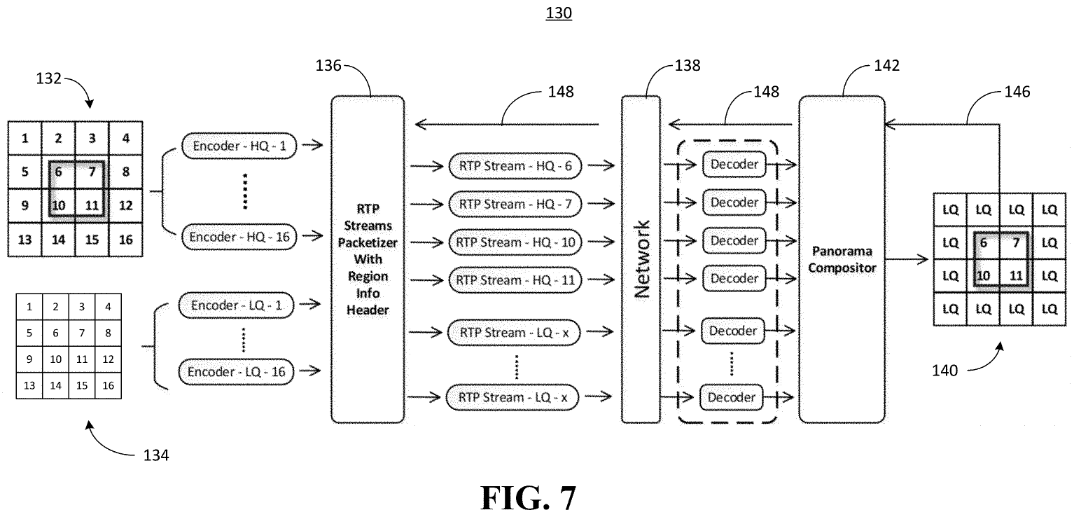

FIG. 7 shows an RTP streaming architecture 130 in which a high quality set 132 of tile streams and a low quality set 134 of tile streams are encoded and sent to a packetizer 136 with region information headers. The illustrated packetizer 136 generates HQ RTP streams for the tiles that are in the current FOV and LQ RTP streams for the tiles that are outside the current FOV. A network 138 (e.g., wired/wireless) transports the RTP streams to a heterogeneous set of decoders that output decoder results to a panorama compositor 142. In an embodiment, the panorama compositor 142 generates a visual output 140, which is used to determine a viewport orientation 146. The panorama compositor 1142 may generate RTP control protocol (RTCP) feedback 148 based on the viewport orientation 146. Thus, the illustrated packetizer 136 selects new RTP streams to output to the network 138 based on the RTCP feedback 148. Other protocols such as, for example, DASH (Dynamic Adaptive Streaming over Hypertext Transfer Protocol) may also be used.

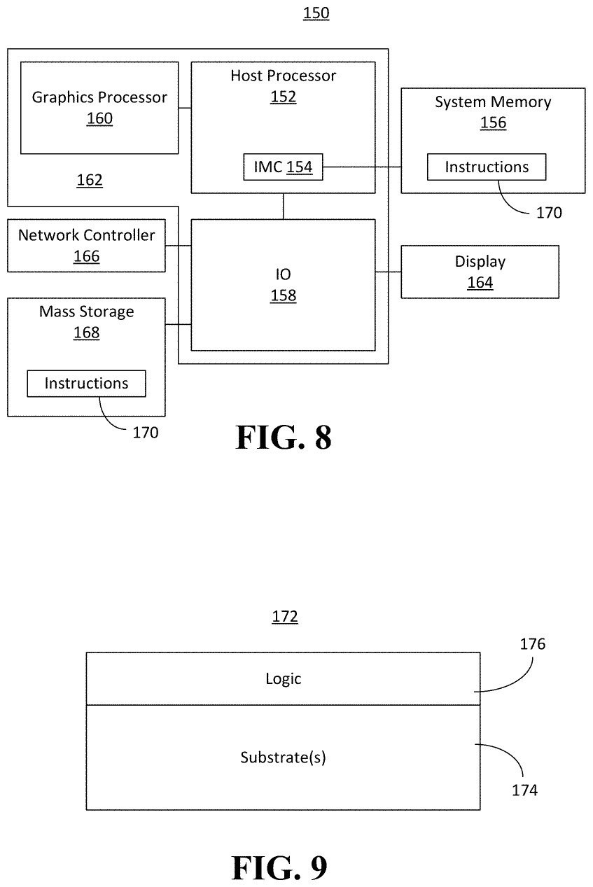

Turning now to FIG. 8, a performance-enhanced computing system 150 is shown. The system 150 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., HMD, watch, eyewear, headwear, footwear, jewelry), vehicular functionality (e.g., car, truck, motorcycle), robotic functionality (e.g., autonomous robot), etc., or any combination thereof. In the illustrated example, the system 150 includes a host processor 152 (e.g., CPU) having an integrated memory controller (IMC) 154 that is coupled to a system memory 156.

The illustrated system 150 also includes an input output (IO) module 158 implemented together with the host processor 152 and a graphics processor 160 (e.g., GPU) on a semiconductor die 162 as a system on chip (SoC). The illustrated IO module 158 communicates with, for example, a display 164 (e.g., touch screen, liquid crystal display/LCD, light emitting diode/LED display, which may include a left-eye display and a right-eye display), a network controller 166 (e.g., wired and/or wireless), and mass storage 168 (e.g., hard disk drive/HDD, optical disk, solid state drive/SSD, flash memory).

The host processor 152, the graphics processor 160 and/or the IO module 158 may execute instructions 170 retrieved from the system memory 156 and/or the mass storage 168. In an embodiment, the computing system 150 is operated as a server and the instructions 170 include executable encoder instructions to perform one or more aspects of the method 100 (FIG. 6A), already discussed. Thus, execution of the illustrated instructions 170 may cause the computing system 150 to select, in response to a request from a client device, a first video stream from a first plurality of video streams dedicated to a first tile in video content. Execution of the instructions 170 may also cause the computing system 150 to select, in response to the request, a second video stream from a second plurality of video streams dedicated to a second tile in the video content. In an embodiment, execution of the instructions 170 also causes the computing system 150 to send the selected first video stream and the selected second video stream to the client device. In one example, the first video stream and the second video stream include one or more different codec parameter values.

In another embodiment, the computing system 150 is operated as a client device and the instructions 170 include executable decoder instructions to perform one or more aspects of the method 120 (FIG. 6B), already discussed. Thus, execution of the illustrated instructions 170 may cause the computing system 150 to allocate a first decoder device to a first video stream, wherein the first video stream is dedicated to a first tile in video content and allocate a second decoder device to a second video stream, wherein the second video stream is dedicated to a second tile in the video content. In one example, the first video stream and the second video stream include one or more different codec parameter values.

Accordingly, the computing system 150 is considered to be performance-enhanced at least to the extent that communication and computation are improved. More particularly, LQ codec parameter values (e.g., lower resolution, lower bit rate, etc.) reduce demand on networking bandwidth in the communication channel between the server and the client device and reduce computational overhead in both the server and the client device. Additionally, scheduling the video streams across a heterogeneous set of decoder devices more efficiently further enhances performance.

FIG. 9 shows a semiconductor apparatus 172 (e.g., chip, die, package). The illustrated apparatus 172 includes one or more substrates 174 (e.g., silicon, sapphire, gallium arsenide) and logic 176 (e.g., transistor array and other integrated circuit/IC components) coupled to the substrate(s) 174. In an embodiment, the apparatus 172 is an encoder semiconductor apparatus and the logic 176 implements one or more aspects of the method 100 (FIG. 6A), already discussed. Thus, the logic 176 may select, in response to a request from a client device, a first video stream from a first plurality of video streams dedicated to a first tile in video content. The logic 176 may also select, in response to the request, a second video stream from a second plurality of video streams dedicated to a second tile in the video content. In an embodiment, the logic 176 also sends the selected first video stream and the selected second video stream to the client device. In one example, the first video stream and the second video stream include one or more different codec parameter values.

In another embodiment, the apparatus 172 is a decoder semiconductor apparatus and the logic 176 implements one or more aspects of the method 120 (FIG. 6B), already discussed. Thus, the logic 176 may allocate a first decoder device to a first video stream, wherein the first video stream is dedicated to a first tile in video content and allocate a second decoder device to a second video stream, wherein the second video stream is dedicated to a second tile in the video content. In one example, the first video stream and the second video stream include one or more different codec parameter values.

Accordingly, the semiconductor apparatus 172 is considered to be performance-enhanced at least to the extent the apparatus 172 improves communication and computation. For example, LQ codec parameter values (e.g., lower resolution, lower bit rate, etc.) reduce demand on networking bandwidth in the communication channel between the server and the client device and reduce computational overhead in both the server and the client device. Additionally, mapping the video streams across a heterogeneous set of decoder devices more efficiently further enhances performance.

The logic 176 may be implemented at least partly in configurable logic or fixed-functionality hardware logic. In one example, the logic 176 includes transistor channel regions that are positioned (e.g., embedded) within the substrate(s) 174. Thus, the interface between the logic 176 and the substrate(s) 174 may not be an abrupt junction. The logic 176 may also be considered to include an epitaxial layer that is grown on an initial wafer of the substrate(s) 174.

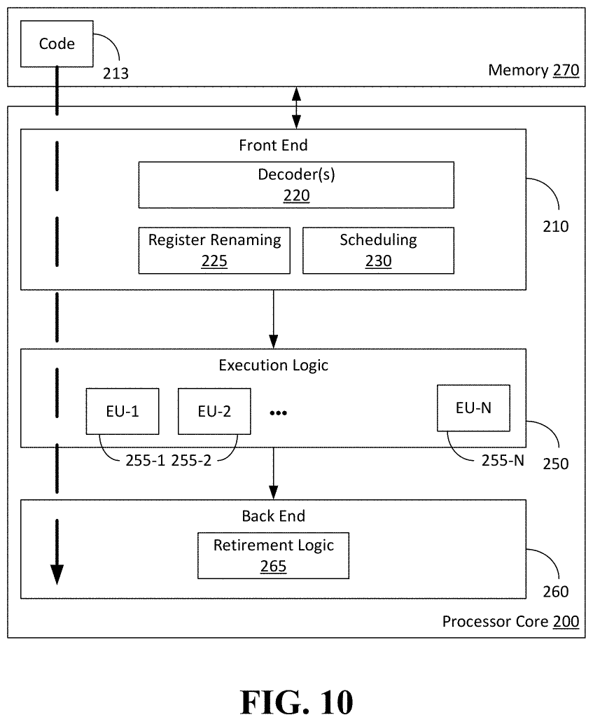

FIG. 10 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 10, a processing element may alternatively include more than one of the processor core 200 illustrated in FIG. 10. The processor core 200 may be a single-threaded core or, for at least one embodiment, the processor core 200 may be multithreaded in that it may include more than one hardware thread context (or “logical processor”) per core.

FIG. 10 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the method 100 (FIG. 6A) and/or the method 120 (FIG. 6B), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 10, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

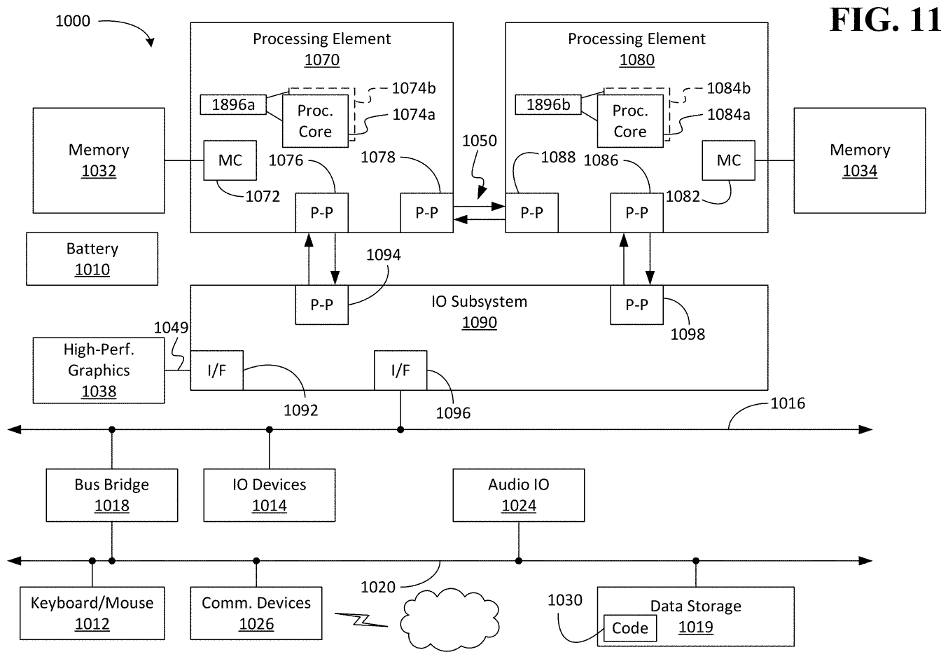

Referring now to FIG. 11, shown is a block diagram of a computing system 1000 embodiment in accordance with an embodiment. Shown in FIG. 11 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 11 may be implemented as a multi-drop bus rather than point-to-point interconnect.

As shown in FIG. 11, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 10.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 11, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 11, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 11, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 100 (FIG. 6A) and/or the method 120 (FIG. 6B), already discussed, and may be similar to the code 213 (FIG. 10), already discussed. Further, an audio I/O 1024 may be coupled to second bus 1020 and a battery 1010 may supply power to the computing system 1000.

Note that other embodiments are contemplated. For example, instead of the point-to-point architecture of FIG. 11, a system may implement a multi-drop bus or another such communication topology. Also, the elements of FIG. 11 may alternatively be partitioned using more or fewer integrated chips than shown in FIG. 11.

### ADDITIONAL NOTES AND EXAMPLES

Example 1 includes a decoder semiconductor apparatus comprising one or more substrates and logic coupled to the one or more substrates, wherein the logic is implemented at least partly in one or more of configurable logic or fixed-functionality hardware logic, the logic coupled to the one or more substrates to allocate a first decoder device to a first video stream, wherein the first video stream is dedicated to a first tile in video content and allocate a second decoder device to a second video stream, wherein the second video stream is dedicated to a second tile in the video content, and wherein the first video stream and the second video stream include one or more different codec parameter values.

Example 2 includes the decoder semiconductor apparatus of Example 1, wherein the one or more different codec parameter values include one or more of a different codec type, a different resolution or a different bit rate.

Example 3 includes the decoder semiconductor apparatus of Example 1, wherein the first decoder device and the second decoder device are allocated based at least in part on a current field of view.

Example 4 includes the decoder semiconductor apparatus of Example 1, wherein the first decoder device and the second decoder device are allocated based at least in part on one or more of a workload state or a power efficiency of the first decoder device and the second decoder device.

Example 5 includes the decoder semiconductor apparatus of Example 1, wherein the first decoder device and the second decoder device are allocated based at least in part on a notification from a server, wherein the notification indicates codec parameter values of a first plurality of video streams including the first video stream and a second plurality of video streams including the second video stream, and wherein the logic coupled to the one or more substrates is to send a request to the server based on the notification, a current field of view and a workload state of the first decoder device and the second decoder device.

Example 6 includes the decoder semiconductor apparatus of any one of Examples 1 to 5, wherein the video content is 360-degree video content.

Example 7 includes at least one computer readable storage medium comprising a set of executable decoder instructions, which when executed by a computing system, cause the computing system to allocate a first decoder device to a first video stream, wherein the first video stream is dedicated to a first tile in video content, and allocate a second decoder device to a second video stream, wherein the second video stream is dedicated to a second tile in the video content, and wherein the first video stream and the second video stream include one or more different codec parameter values.

Example 8 includes the at least one computer readable storage medium of Example 7, wherein the one or more different codec parameter values include one or more of a different codec type, a different resolution or a different bit rate.

Example 9 includes the at least one computer readable storage medium of Example 7, wherein the first decoder device and the second decoder device are allocated based at least in part on a current field of view.

Example 10 includes the at least one computer readable storage medium of Example 7, wherein the first decoder device and the second decoder device are allocated based at least in part on one or more of a workload state or a power efficiency of the first decoder device and the second decoder device.

Example 11 includes the at least one computer readable storage medium of Example 7, wherein the first decoder device and the second decoder device are allocated based at least in part on a notification from a server, wherein the notification indicates codec parameter values of a first plurality of video streams including the first video stream and a second plurality of video streams including the second video stream, and wherein the instructions, when executed, cause the computing system to send a request to the server based on the notification, a current field of view and one or more of a workload state or a power efficiency of the first decoder device and the second decoder device.

Example 12 includes the at least one computer readable storage medium of any one of Examples 7 to 11, wherein the video content is 360-degree video content.

Example 13 includes a performance-enhanced computing system comprising a network controller, a processor coupled to the network controller, and a memory coupled to the processor, the memory including a set of executable decoder instructions, which when executed by a computing system, cause the computing system to allocate a first decoder device to a first video stream, wherein the first video stream is dedicated to a first tile in video content, and allocate a second decoder device to a second video stream, wherein the second video stream is dedicated to a second tile in the video content, and wherein the first video stream and the second video stream include one or more different codec parameter values.

Example 14 includes the computing system of Example 13, wherein the one or more different codec parameter values include one or more of a different codec type, a different resolution or a different bit rate.

Example 15 includes the computing system of Example 13, wherein the first decoder device and the second decoder device are allocated based at least in part on a current field of view.

Example 16 includes the computing system of Example 13, wherein the first decoder device and the second decoder device are allocated based at least in part on one or more of a workload state or a power efficiency of the first decoder device and the second decoder device.

Example 17 includes the computing system of Example 13, wherein the first decoder device and the second decoder device are allocated based at least in part on a notification from a server, wherein the notification indicates codec parameter values of a first plurality of video streams including the first video stream and a second plurality of video streams including the second video stream, and wherein the instructions, when executed, cause the computing system to send a request to the server based on the notification, a current field of view and one or more of a workload state or a power efficiency of the first decoder device and the second decoder device.

Example 18 includes the computing system of any one of Examples 13 to 17, wherein the video content is 360-degree video content.

Example 19 includes a method of operating a decoder, the method comprising allocating a first decoder device to a first video stream, wherein the first video stream is dedicated to a first tile in video content, and allocating a second decoder device to a second video stream, wherein the second video stream is dedicated to a second tile in the video content, and wherein the first video stream and the second video stream include one or more different codec parameter values.

Example 20 includes the method of Example 19, wherein the one or more different codec parameter values include one or more of a different codec type, a different resolution or a different bit rate.

Example 21 includes the method of Example 19, wherein the first decoder device and the second decoder device are allocated based at least in part on a current field of view.

Example 22 includes the method of Example 19, wherein the first decoder device and the second decoder device are allocated based at least in part on one or more of a workload state or a power efficiency of the first decoder device and the second decoder device.

Example 23 includes the method of Example 19, wherein the first decoder device and the second decoder device are allocated based at least in part on a to notification from a server, wherein the notification indicates codec parameter values of a first plurality of video streams including the first video stream and a second plurality of video streams including the second video stream, and wherein the method further including sending a request to the server based on the notification, a current field of view and one or more of a workload state or a power efficiency of the first decoder device and the second decoder device.

Example 24 includes the method of any one of Examples 19 to 23, wherein the video content is 360-degree video content.

Example 25 includes an encoder semiconductor apparatus comprising one or more substrates, and logic coupled to the one or more substrates, wherein the logic is implemented at least partly in one or more of configurable logic or fixed-functionality hardware logic, the logic coupled to the one or more substrates to select, in response to a request from a client device, a first video stream from a first plurality of video streams dedicated to a first tile in video content, select, in response to the request, a second video stream from a second plurality of video streams dedicated to a second tile in the video content, and send the selected first video stream and the selected second video stream to the client device.

Example 26 includes the encoder semiconductor apparatus of Example 25, wherein the first video stream and the second video stream include one or more different codec parameter values.

Example 27 includes the encoder semiconductor apparatus of Example 26, wherein the one or more different codec parameter values include one or more of a different codec type, a different resolution or a different bit rate.

Example 28 includes the encoder semiconductor apparatus of Example 25, wherein the logic coupled to the one or more substrates is to send a notification to the client device, wherein the notification indicates codec parameter values of the first plurality of video streams and the second plurality of video streams.

Example 29 includes the encoder semiconductor apparatus of Example 25, wherein the logic coupled to the one or more substrates is to partition the video content into a plurality of tiles including the first tile and the second tile.

Example 30 includes the encoder semiconductor apparatus of any one of Examples 25 to 29, wherein the video content is 360-degree video content.

Example 31 includes at least one computer readable storage medium comprising a set of executable encoder instructions, which when executed by a computing system, cause the computing system to select, in response to a request from a client device, a first video stream from a first plurality of video streams dedicated to a first tile in video content, select, in response to the request, a second video stream from a second plurality of video streams dedicated to a second tile in the video content, and send the selected first video stream and the selected second video stream to the client device.

Example 32 includes the at least one computer readable storage medium of Example 31, wherein the first video stream and the second video stream include one or more different codec parameter values.

Example 33 includes the at least one computer readable storage medium of Example 32, wherein the one or more different codec parameter values include one or more of a different codec type, a different resolution or a different bit rate.

Example 34 includes the at least one computer readable storage medium of Example 31, wherein the instructions, when executed, cause the computing system to send a notification to the client device, wherein the notification indicates codec parameter values of the first plurality of video streams and the second plurality of video streams.

Example 35 includes the at least one computer readable storage medium of Example 31, wherein the instructions, when executed, cause the computing system to partition the video content into a plurality of tiles including the first tile and the second tile.

Example 36 includes the at least one computer readable storage medium of any one of Examples 31 to 35, wherein the video content is 360-degree video content.

Example 37 includes a method of operating an encoder, the method comprising selecting, in response to a request from a client device, a first video stream from a first plurality of video streams dedicated to a first tile in video content, selecting, in response to the request, a second video stream from a second plurality of video streams dedicated to a second tile in the video content, and sending the selected first video stream and the selected second video stream to the client device.

Example 38 includes the method of Example 37, wherein the first video stream and the second video stream include one or more different codec parameter values.

Example 39 includes the method of Example 38, wherein the one or more different codec parameter values include one or more of a different codec type, a different resolution or a different bit rate.

Example 40 includes the method of Example 37, further including sending a notification to the client device, wherein the notification indicates codec parameter values of the first plurality of video streams and the second plurality of video streams.

Example 41 includes the method of Example 37, further including partitioning the video content into a plurality of tiles including the first tile and the second tile.

Example 42 includes the method of any one of Examples 37 to 41, wherein the video content is 360-degree video content.

Example 43 includes a performance-enhanced computing system comprising a network controller, a processor coupled to the network controller, and memory coupled to the processor, the memory including a set of executable encoder instructions, which when executed by a computing system, cause the computing system to select, in response to a request from a client device, a first video stream from a first plurality of video streams dedicated to a first tile in video content, select, in response to the request, a second video stream from a second plurality of video streams dedicated to a second tile in the video content, and send the selected first video stream and the selected second video stream to the client device.

Example 44 includes the computing system of Example 43, wherein the first video stream and the second video stream include one or more different codec parameter values.

Example 45 includes the computing system of Example 44, wherein the one or more different codec parameter values include one or more of a different codec type, a different resolution or a different bit rate.

Example 46 includes the computing system of Example 43, wherein the instructions, when executed, cause the computing system to send a notification to the client device, wherein the notification indicates codec parameter values of the first plurality of video streams and the second plurality of video streams.

Example 47 includes the computing system of Example 43, wherein the instructions, when executed, cause the computing system to partition the video content into a plurality of tiles including the first tile and the second tile.

Example 48 includes the computing system of any one of Examples 43 to 47, wherein the video content is 360-degree video content.

Example 49 includes means for performing the method of any one of Examples 19 to 24.

Example 50 includes means for performing the method of any one of Examples 37 to 42.

Thus, technology described herein may better exploit the capability of heterogeneous architectures. Unlike traditional codecs, which are limited to specific kinds of computation units, the technology described herein lifts tiles to streams so that each tile may be assigned to a different computation unit.

Additionally, dynamic scheduling of heterogeneous decoders facilitates workload balancing and error resilience. Through the ONEAPI level 0 manager, multiple streams may be dynamically dispatched to heterogeneous decoders. The ONEAPI level 0 manager monitors the workloads of all hardware decoders and seamlessly migrates streams among decoders (e.g., switching at key frames) in response to decoder overload to improve workload balance and/or error resilience, without upper layer awareness.

Moreover, greater backward compatibility is achieved because the technology does not rely on new tile-based codecs like HEVC (High Efficiency Video Coding) codecs. Solutions may use existing codecs and leverage different kinds of optimizations and accelerations already in place on the client side. Additionally, the technology provides greater flexibility of enabling various kinds of streaming protocols such as RTP, DASH, and so forth.

The unified programming model of ONEAPI enables a viable path and developer friendly interface to fully exploit various types of computing resources such as, for example, CPU, GPU, VPU (video processing unit), FPGA and so on.

The heterogeneous model enabled by the technology described herein extends the ONEAPI model to streaming, with an easier-to-use and more ready-to-adapt solution that benefits developers in delivering a better user experience. The technology uses ONEAPI to 1) detect all available computation resources to intelligently allocate decoding tasks, 2) use a unified interface to invoke decoders even if they are allocated on different hardware components, and 3) dynamically schedule to different hardware computation components for workload balance and error resilience.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1-24. (canceled)

25. A decoder semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
allocate a first decoder device to a first video stream, wherein the first video stream is dedicated to a first tile in video content; and
allocate a second decoder device to a second video stream, wherein the second video stream is dedicated to a second tile in the video content, and wherein the first video stream and the second video stream include one or more different codec parameter values.

26. The decoder semiconductor apparatus of claim 25, wherein the one or more different codec parameter values include one or more of a different codec type, a different resolution or a different bit rate.

27. The decoder semiconductor apparatus of claim 25, wherein the first decoder device and the second decoder device are allocated based at least in part on a current field of view.

28. The decoder semiconductor apparatus of claim 25, wherein the first decoder device and the second decoder device are allocated based at least in part on one or more of a workload state or a power efficiency of the first decoder device and the second decoder device.

29. The decoder semiconductor apparatus of claim 25, wherein the first decoder device and the second decoder device are allocated based at least in part on a notification from a server, wherein the notification indicates codec parameter values of a first plurality of video streams including the first video stream and a second plurality of video streams including the second video stream, and wherein the logic coupled to the one or more substrates is to send a request to the server based on the notification, a current field of view and a workload state of the first decoder device and the second decoder device.

30. The decoder semiconductor apparatus of claim 25, wherein the video content is 360-degree video content.

31. At least one computer readable storage medium comprising a set of executable decoder instructions, which when executed by a computing system, cause the computing system to:
allocate a first decoder device to a first video stream, wherein the first video stream is dedicated to a first tile in video content; and
allocate a second decoder device to a second video stream, wherein the second video stream is dedicated to a second tile in the video content, and wherein the first video stream and the second video stream include one or more different codec parameter values.

32. The at least one computer readable storage medium of claim 31, wherein the one or more different codec parameter values include one or more of a different codec type, a different resolution or a different bit rate.

33. The at least one computer readable storage medium of claim 31, wherein the first decoder device and the second decoder device are allocated based at least in part on a current field of view.

34. The at least one computer readable storage medium of claim 31, wherein the first decoder device and the second decoder device are allocated based at least in part on one or more of a workload state or a power efficiency of the first decoder device and the second decoder device.

35. The at least one computer readable storage medium of claim 31, wherein the first decoder device and the second decoder device are allocated based at least in part on a notification from a server, wherein the notification indicates codec parameter values of a first plurality of video streams including the first video stream and a second plurality of video streams including the second video stream, and wherein the instructions, when executed, cause the computing system to send a request to the server based on the notification, a current field of view and one or more of a workload state or a power efficiency of the first decoder device and the second decoder device.

36. The at least one computer readable storage medium of claim 31, wherein the video content is 360-degree video content.

37. A performance-enhanced computing system comprising:
a network controller;
a processor coupled to the network controller; and
a memory coupled to the processor, the memory including a set of executable decoder instructions, which when executed by a computing system, cause the computing system to:
allocate a first decoder device to a first video stream, wherein the first video stream is dedicated to a first tile in video content; and
allocate a second decoder device to a second video stream, wherein the second video stream is dedicated to a second tile in the video content, and wherein the first video stream and the second video stream include one or more different codec parameter values.

38. The computing system of claim 37, wherein the one or more different codec parameter values include one or more of a different codec type, a different resolution or a different bit rate.

39. The computing system of claim 37, wherein the first decoder device and the second decoder device are allocated based at least in part on a current field of view.

40. The computing system of claim 37, wherein the first decoder device and the second decoder device are allocated based at least in part on one or more of a workload state or a power efficiency of the first decoder device and the second decoder device.

41. The computing system of claim 37, wherein the first decoder device and the second decoder device are allocated based at least in part on a notification from a server, wherein the notification indicates codec parameter values of a first plurality of video streams including the first video stream and a second plurality of video streams including the second video stream, and wherein the instructions, when executed, cause the computing system to send a request to the server based on the notification, a current field of view and one or more of a workload state or a power efficiency of the first decoder device and the second decoder device.

42. The computing system of claim 37, wherein the video content is 360-degree video content.

43. A method of operating a decoder, the method comprising:
allocating a first decoder device to a first video stream, wherein the first video stream is dedicated to a first tile in video content; and
allocating a second decoder device to a second video stream, wherein the second video stream is dedicated to a second tile in the video content, and wherein the first video stream and the second video stream include one or more different codec parameter values.

44. The method of claim 44, wherein the one or more different codec parameter values include one or more of a different codec type, a different resolution or a different bit rate.

45. The method of claim 44, wherein the first decoder device and the second decoder device are allocated based at least in part on a current field of view.

46. The method of claim 44, wherein the first decoder device and the second decoder device are allocated based at least in part on one or more of a workload state or a power efficiency of the first decoder device and the second decoder device.

47. The method of claim 44, wherein the first decoder device and the second decoder device are allocated based at least in part on a notification from a server, wherein the notification indicates codec parameter values of a first plurality of video streams including the first video stream and a second plurality of video streams including the second video stream, and wherein the method further including sending a request to the server based on the notification, a current field of view and one or more of a workload state or a power efficiency of the first decoder device and the second decoder device.

48. The method of claim 44, wherein the video content is 360-degree video content.
